(19) United States
(12) Patent Application Publication
(10) Pub. No.: US 2009/0055534 A1
(43) Pub. Date: Feb. 26, 2009

(54) TIERED NETWORK STRUCTURE FOR LARGE CE DEVICE POPULATIONS

(75) Inventors: Aran Sadja, San Diego, CA (US); Eric Holcomb, San Marcos, CA (US); Lee Pedlow, Ramona, CA (US)

Correspondence Address: ROGITZ & ASSOCIATES, 750 B STREET, SUITE 3120, SAN DIEGO, CA, 92101, US

(73) Assignees: Sony Corporation; Sony Electronics, Inc

(21) Appl. No.: 11/843,156

(22) Filed: Aug. 22, 2007

(51) Int. Cl. G06F 15/173

(52) U.S. Cl. 709/226

(57) ABSTRACT

Consumer electronic (CE) devices can each store a concierge network address of a centralized information server (CIS). In response to receiving a model number from a CE device, the CIS can return a list of resources available to the CE device, including network addresses for an update list server providing the CE device with a list of current software available for download to the CE device, a news link server providing the CE device with a list of news feeds, and a video/music list server providing a list of video and/or music available to the CE device.

### I. FIELD OF THE INVENTION

The present invention relates generally to tiered network structures for large consumer electronic (CE) device populations, such as but not limited to Internet-enabled TVs.

### II. BACKGROUND OF THE INVENTION

Consumer electronic (CE) devices such as televisions in the past have not required a network support structure. Instead, a TV, for instance, simply required a receiver and tuner in the proper frequency bands to receive signals from a broadcast or from a cable head end or satellite.

As understood herein, such non-computer consumer devices increasingly have become networked. For example, so-called Internet TVs not only receive conventional TV signals but also access the Internet as a way to increase the variety and numbers of programs that can be made available to a viewer.

As also understood herein, unlike computers, which have various forms of user input (keyboard, mouse, etc), many CE devices have simple interfaces which make entering a network address or location difficult. Thus, the present invention recognizes the desirability for CE devices that are intended to be networked to leave the factory with some knowledge of the network structure they will be communicating with. Moreover, such information typically can be expected to be hard-coded and unchangeable once production begins. However, the present invention critically recognizes that hard-coding in advance every possible network address that might be required during the lifetime of the CE device is problematic.

### SUMMARY OF THE INVENTION

By creating a tiered network infrastructure, the amount of hard-coded information that must be stored on resource limited devices is reduced, allowing for maximum flexibility. The invention thus supports large populations of CE devices such as Internet-enabled TVs with a tiered network structure having a root node.

In one aspect, a single network address is provided at manufacturing time on a data storage of a CE device such as a TV having a model number. A user of the CE device can use the single network address to access a central information server (CIS), which informs the CE device, based at least in part on the model number or other device-specific information, of network addresses of, e.g., a news feed server and a video/music server.

In another aspect, a consumer electronic (CE) device such as a TV has a processor in a housing and a data storage in the housing and accessible to the processor. The storage contains a hard-coded network address of a centralized information server (CIS) accessible to the CE device over a wide area computer network to receive a list of resources available to the CE device.

In still another aspect, plural consumer electronic (CE) devices, each having a respective memory with a concierge network address stored therein, can access a centralized information server (CIS) accessible to a CE device over a wide area computer network and associated with the concierge network address. The CIS receives a model number or other device-specific information of the CE device and returns to the CE device a list of resources available to the CE device. The list can include network addresses for an update list server, a news link server, and a video/music list server. The update list server can provide the CE device with a list of current software available for download to the CE device. On the other hand, the news link server can provide the CE device with a list of news feeds available to the CE device, with the video/music list server providing the CE device with a list of video and/or music available to the CE device.

The list of resources provided by the CIS to the CE device preferably is based on the model number of the CE device and, if desired, on a geographic region of the CE device.

In specific embodiments, the CE device, using the list of resources from the CTS, may provide a model number of the CE device to the update list server, and the update list server in response can provide the CE device with a list of current software available for download to the CE device based on the model number. The list of current software may include network addresses of sites where updates can be obtained. The CE device can use a network address of a site where updates can be obtained to establish communication with the site and obtain software updates over the wide area computer network.

In some embodiments the news link server provides the CE device with a list of news feeds available to the CE device based on the model number. The list of news feeds may include network addresses of sites where news feeds can be obtained, and the CE device can use a network address of a site where news feeds can be obtained to establish communication with the site and obtain a news feed over the wide area computer network. In such embodiments, an entity associated with the site where news feeds can be obtained may pay remuneration to an entity associated with the CIS in response to the CE device obtaining a news feed from the site where news feeds can be obtained.

In some embodiments the video/music list server can provide the CE device with a list of video and/or music available to the CE device based on the model number. The list of video and/or music can include network addresses of sites where video and/or music can be obtained, and the CE device can use a one network address of a site where video and/or music can be obtained to establish communication with the site and obtain at least one video and/or music file over the wide area computer network. In such embodiments, the CE device may send account information to the video/music list server. In return, the video/music list server can provide an authorization token to the CE device. The token can be sent from the CE device to the site where video and/or music can be obtained. An entity associated with the site where video and/or music can be obtained can then bill an entity associated with the video/music link server in accordance with the token.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a tiered network system in accordance with one embodiment of the present invention;

FIG. 2 is a non-limiting flow chart of the concierge logic;

FIG. 3 is a non-limiting flow chart of the update logic;

FIG. 4 is a non-limiting flow chart of the news feed logic; and

FIG. 5 is a non-limiting flow chart of the video/music service logic.

### DETAILED DESCRIPTION OF THE PREFERRED EMBODIMENT

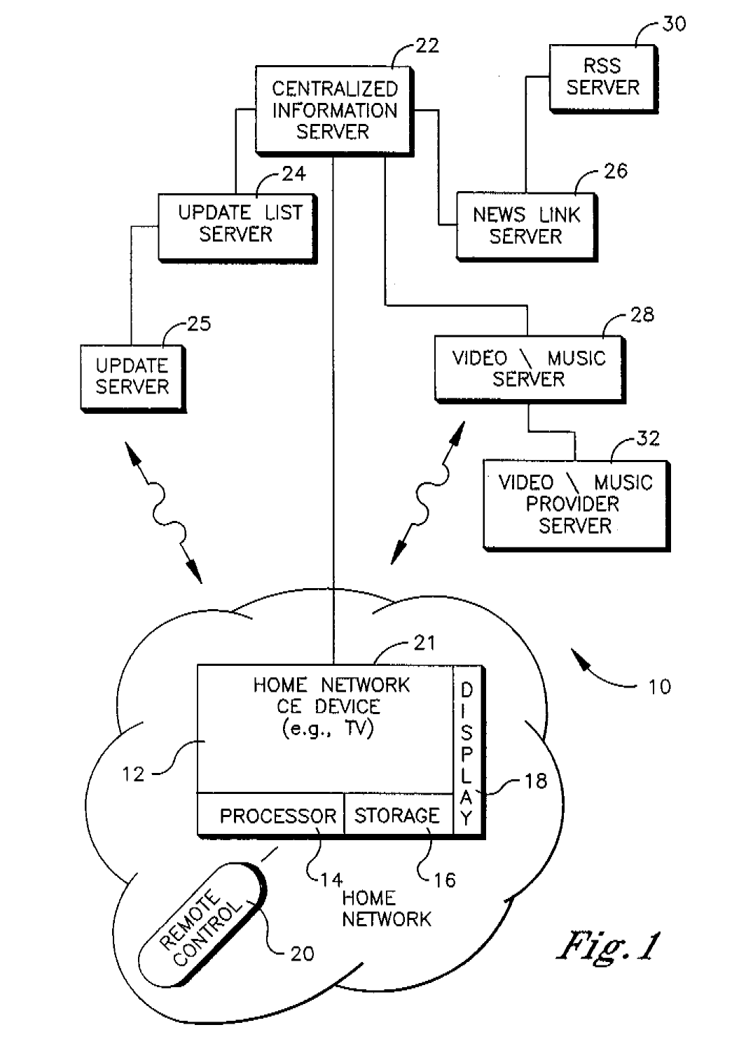

Referring initially to FIG. 1, a system is shown, generally designated 10, which includes plural consumer electronics (CE) devices 12 (only a single CE device shown for clarity) such as televisions, cameras, notebook computers, etc. Each CE device 12 includes a processor 14 that can access a data storage 16 such as solid state storage or disk-based storage. The processor 14 may control an audio and/or video display 18 in accordance with commands received wirelessly from a remote commander 20, with the processor 14, storage 16, and display 18 supported on a housing 21. The storage 16 need contain, preferably although not exclusively hard-coded, a single network address such as an Internet uniform resource listing (URL), Internet Protocol (IP) address, etc. in its permanent memory, with the network address being associated with a “concierge” or central information server (CIS) 22 that can communicate with the CE device 12 over a wide area network such as the Internet. In a non-limiting embodiment the CIS server 22 can be a hypertext transfer protocol, secure (HTTPS) server having a so-called “LAMP” architecture (Linux Apache MySql PHP). The servers discussed below can be similar servers.

As set forth further below, the CIS 22 provides CE products 12 with a list of network addresses where additional services can be found. The addresses can correspond to an update list server 24, which in turn can provide a list of addresses of update servers 25. In other words, the update list server 24 can itself maintain a list of updates, and if desired the update binaries may reside on a separate server 25 for added flexibility. The addresses provided by the CIS server 22 can also include the address of a news link server 26 and a video/music server 28. At least the update list server 24 and news link server 26 can be integrated into the CIS server 22 if desired. The news link server 26 can in turn provide lists of addresses of resource description framework (RDF) site summary (RSS) servers 30, while the video/music server 28 can in turn provide lists of addresses of video/music provider servers 32 at which music and/or video programs/files can be obtained.

With the above architecture in mind and as described further below, the CIS 22 recognizes a contacting CE device 12 and provides redirection to the various resources the device requires. Unlike the CIS 22 address that is permanently stored on the device 12, the resource list provided by the CIS 22 to the device 12 can be updated when a service must be relocated or updated, with no need for a software upgrade on the CE device 12. The list of resources the CIS 22 maintains may contain a single location per service, or the CIS 22 may keep a list of multiple locations per service. In this way, the CIS 22 can act as a software load balancer, localizer, and an automated failure solution by decisively choosing which address a particular device will receive in its server list.

The format of the above-mentioned lists can be proprietary or based on open standards. In one implementation, extensible markup language (XML) is used for the lists to provide an easily readable solution both to CE devices 12 and to developers of the system.

The communication protocol used in the below-described logic can be transmission control protocol (TCP), hypertext transfer protocol (HTTP), extensible messaging and presence protocol (XMPP), or other appropriate protocol. Because many networks have firewalls that limit inbound and outbound traffic, the use of a standard port for communication (e.g., port 80) simplifies integration into the home or office environment. The servers mentioned above all contain respective processors and data stores.

Turning now to FIG. 2, at block 34, upon booting the CE device 12 (such as a TV) sends information specific or unique to it, such as its model number, and in some embodiments its geographic region (which can be preentered by the user during setup) to the CIS server 22, using, e.g., HTTP. Or, instead of being actively supplied by the user, the geographic information may be passively supplied in that it may be determined by the recipient computer from the IP address of the CE device 12. Other actively supplied information that may be entered by the user into the CE device 12 can be rating preferences and language preferences.

In response, at block 36 the CIS 22 returns to the CE device 12 the above-discussed resource list in, e.g., XML. The resource list thus may be tailored to the model number of the CE device 12 and further, in some embodiments, to passively-supplied or actively-supplied information related to the device 12 such as, e.g., the geographic region of the device, rating preferences, and language preferences. The resource list is stored by the CE device 12 at block 38.

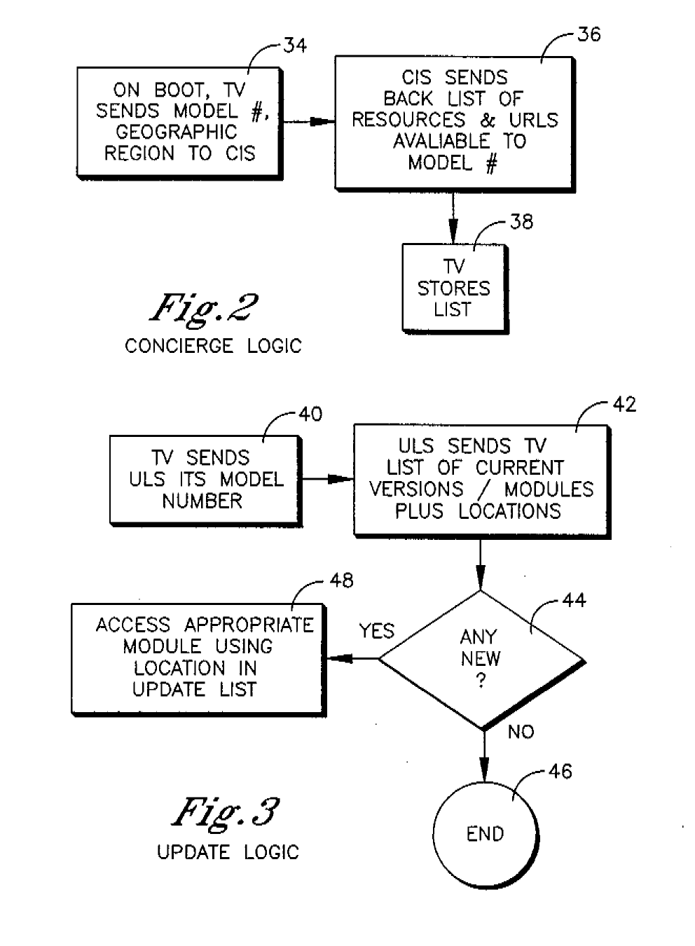

Now considering the update list server 24 and the logic of FIG. 3, the CE device 12 obtains the address of the ULS 24 from the resource list sent by the CIS 22, and at block 40 sends the ULS 24 its model number using, e.g., HTTPS. Based on the model number, at block 42 the ULS 24 sends the CE device 12 a list of current software/module versions for the model number of the device along with network addresses of locations where the updates can be obtained using, e.g., XML. If the device 12 determines at decision diamond 44 that any of the versions are not new, the logic ends at state 46, but otherwise the appropriate software provider server 25 is accessed at block 48 using the corresponding address on the update list provided at block 42 using, e.g., HTTPS. In some implementations updates are sent automatically to the device 12 without request from the device 12, once the device 12 is connected.

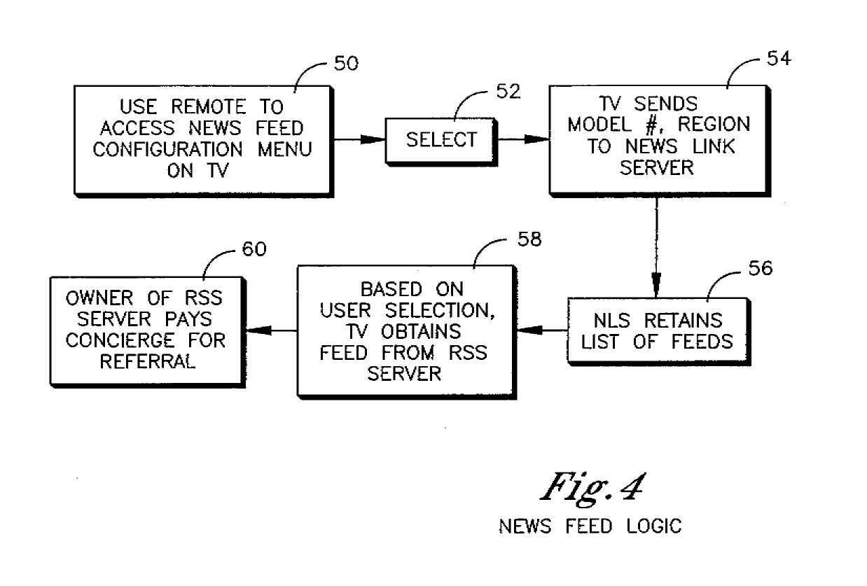

Moving to FIG. 4 and the news link server 26, at block 50 the user of the CE device 12 can use, e.g., the remote commander 20 to access a news feed configuration menu that can be presented on the display 18. The option “get news feeds” can be selected at block 52 by appropriately manipulating the remote commander 20. If desired, the news feed configuration menu can permit the user to specify a news type or organization from which the user desires to obtain a news feed.

Proceeding to block 54, the CE device 12 automatically sends its model number and, in some embodiments, its geographic region to the news link server 26. This automatic transmission, which can be in HTTP, can be effected in response to the user making the selection at block 52. In response and based on the model number and if desired geographic region of the CE device 12, at block 56 the news link server 26 sends (via, e.g., XML) to the device 12 a list of news feeds and corresponding addresses of servers 30 at which desired news feeds may be obtained. The addresses may not necessarily be presented to the user, only the names of the news feeds. The user can select a news feed from the list at block 58 using, e.g., the remote commander 20 to obtain the news feed, which can be presented on the display 18. At block 60, the owner or other affiliate of the RSS server 30 from which the news feed is obtained can pay the owner or other affiliate of the CIS server 22 for the referral.

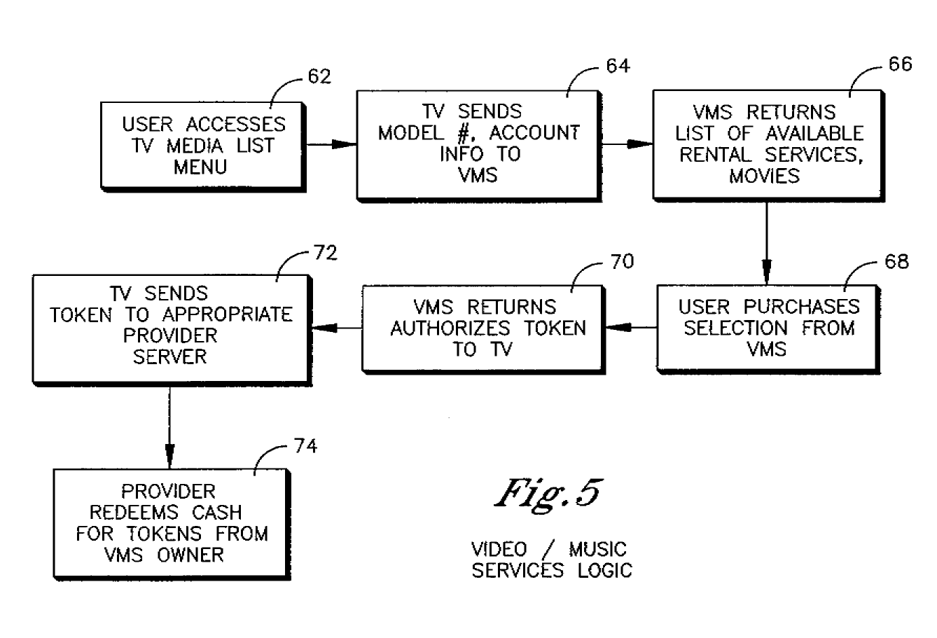

Concluding with FIG. 5 and an exposition of the logic for obtaining video and/or music streams and/or files that can be saved to the storage 16 of the CE device 12 for presentation on the display 18, at block 62 the user can manipulate the remote commander 20 to access a TV media list menu that is presented on the display 18. The user can select to obtain video and/or music, hereinafter “multimedia”. In response to the selection, at block 64 the CE device 12 sends the device 12 model number and user account information (which can be pre-entered by the user during setup) to the VMS 28, and in response the VMS 28 returns to the CE device 12, at block 66, a list of available rental services, movies, etc. along with corresponding network addresses. At block 68 the user can manipulate the remote commander 20 to select a title from the list for purchase, and the VMS 28 can return an authorization token to the CE device 12 at block 70. With this token, the CE device 12 can access the provider server 32 that is associated with the select title at block 72 to obtain the desired multimedia. The provider server 32 sends the multimedia to the CE device 12 for display thereon, and if desired at block 74 redeems cash or other remuneration from the owner or other affiliate of the VMS 28 using the token from the CE device 12.

While the particular TIERED NETWORK STRUCTURE FOR LARGE CE DEVICE POPULATIONS is herein shown and described in detail, it is to be understood that the subject matter which is encompassed by the present invention is limited only by the claims.

What is claimed is:

1. A system, comprising:
plural consumer electronic (CE) devices, each having a respective memory with a concierge network address stored therein;
a centralized information server (CIS) accessible to a CE device over a wide area computer network and associated with the concierge network address;
an update list server;
a news link server; and
a video/music list server:
the CIS receiving, from at least one of the CE devices, at least a model number of the CE device, the CIS returning to the CE device a list of resources available to the CE device, the update list server providing the CE device with a list of current software available for download to the CE device, the news link server providing the CE device with a list of news feeds available to the CE device, the video/music list server providing the CE device with a list of video and/or music available to the CE device.

2. The system of claim 1, wherein the list of resources provided by the CIS to the CE device is based on the model number of the CE device.

3. The system of claim 2, wherein the list of resources provided by the CIS to the CE device is based on a geographic region of the CE device.

4. The system of claim 1, wherein the CE device, using the list of resources from the CIS, provides a model number of the CE device to the update list server, the update list server providing the CE device with a list of current software available for download to the CE device based on the model number, the list of current software including network addresses of sites where updates can be obtained, the CE device using at least one network address of a site where updates can be obtained to establish communication with the site and obtain at least one software update over the wide area computer network.

5. The system of claim 1, wherein the CE device, using the list of resources from the CIS, provides a model number of the CE device to the news link server, the news link server providing the CE device with a list of news feeds available to the CE device based on the model number, the list of news feeds including network addresses of sites where news feeds can be obtained, the CE device using at least one network address of a site where news feeds can be obtained to establish communication with the site and obtain at least one news feed over the wide area computer network.

6. The system of claim 5, wherein an entity associated with the site where news feeds can be obtained pays remuneration to an entity associated with the CIS in response to the CE device obtaining a news feed from the site where news feeds can be obtained.

7. The system of claim 1, wherein the CE device, using the list of resources from the CIS, provides a model number of the CE device to the video/music list server, the video/music list server providing the CE device with a list of video and/or music available to the CE device based on the model number, the list of video and/or music including network addresses of sites where video and/or music can be obtained, the CE device using at least one network address of a site where video and/or music can be obtained to establish communication with the site and obtain at least one video and/or music file over the wide area computer network.

8. The system of claim 7, wherein the CE device sends account information to the video/music list server, the video/music list server providing an authorization token to the CE device, the token being sent from the CE device to the site where video and/or music can be obtained, an entity associated with the site where video and/or music can be obtained billing an entity associated with the video/music link server in accordance with the token.

9. A consumer electronic (CE) device, comprising:
a processor in a housing; and
a data storage in the housing and accessible to the processor, the storage containing a hard-coded network address of a centralized information server (CIS) accessible to the CE device over a wide area computer network to receive a list of resources available to the CE device.

10. The CE device of claim 9, wherein the CE device is configured to send information unique to it to the CIS to obtain the list of resources.

11. The CE device of claim 10, wherein the list of resources includes network addresses for an update list server, a news link server, and a video/music list server.

12. The CE device of claim 11, wherein the CE device is configured to send its model number to the update list server and in response receiving therefrom a list of current software available for download to the CE device along with network addresses from which the software may be obtained.

13. The CE device of claim 11, wherein the CE device is configured to send its model number to the news link server and in response receiving therefrom a list of news feeds and associated network addresses available to the CE device.

14. The CE device of claim 11, wherein the CE device is configured to send its model number to the video/music list server and in response receiving therefrom a list of video and/or music files and associated network addresses available to the CE device.

15. The device of claim 11, wherein the CE device is configured to send passively entered and/or actively entered user information to the CIS to obtain the list of resources, the user information including one or more of geographic region information, ratings preferences, language preferences.

16. A method, comprising:
providing a single network address on a data storage of a CE device having unique identifying information;
enabling a user of the CE device to use the single network address to access a central information server (CIS); and
using the CIS to inform the CE device, based at least in part on the unique identifying information, of network addresses of at least a news feed server and a video/music server.

17. The method of claim 16, further comprising using the CIS to inform the CE device, based at least in part on the unique identifying information, of a network address of a software update list server.

18. The method of claim 16, wherein the news link server provides the CE device with a list of news feeds available to the CE device based on the unique identifying information, the list of news feeds including network addresses of sites where news feeds can be obtained.

19. The method of claim 18, wherein an entity associated with a site where news feeds can be obtained pays remuneration to an entity associated with the CIS in response to the CE device obtaining a news feed from the site where news feeds can be obtained.

20. The method of claim 16, wherein the video/music list server provides the CE device with a list of video and/or music available to the CE device based on the unique identifying information, the list of video and/or music including network addresses of sites where video and/or music can be obtained, the CE device using at least one network address of a site where video and/or music can be obtained to establish communication with the site and obtain at least one video and/or music file over the wide area computer network, and further wherein the method comprises:
enabling the CE device to send account information to the video/music list server, the video/music list server providing an authorization token to the CE device, the token being sent from the CE device to the site where video and/or music can be obtained, an entity associated with the site where video and/or music can be obtained billing an entity associated with the video/music link server in accordance with the token.
